(19) United States
(12) Patent Application Publication
(10) Pub. No.: US 2008/0053979 A1
(43) Pub. Date: Mar. 6, 2008

(54) Hand warmer

(76) Inventors: Shoichi Toya, Minamiawaji-shi (JP); Masao Yamaguchi, Sumoto-shi (JP); Kazuhiro Toyoda, Sumoto-shi (JP); Koichi Fukukawa, Sumoto-shi (JP); Masayoshi Hattori, Minamiawaji-shi (JP); Toshiki Nakasho, Sumoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/889,295

(22) Filed: Aug. 10, 2007

(30) Foreign Application Priority Data
Aug. 11, 2006 (JP) 2006-220714
Oct. 27, 2006 (JP) 2006-292527
Aug. 6, 2007 (JP) 2007-204766

(51) Int. Cl. H05B 1/00; F27D 19/00; H05B 1/02; F27D 23/00

(52) U.S. Cl. 219/201; 219/385; 219/489; 219/494

(57) ABSTRACT

In a hand warmer, a heat dissipating plate is thermally coupled to a heater that is supplied with current by a battery that is accommodated in a case. The battery is a box-shaped rechargeable battery of a box-shaped rechargeable lithium-ion battery or lithium-polymer battery that has flat surfaces opposed to each other. The heater is a heating element that is opposed to the flat surface of the battery. A shielding plate is arranged between the heating element and the flat surface of the battery. The heat dissipating plate that is thermally coupled to the heating element is secured to the case on the surface side of the case. In the hand warmer, the flat surface of the box-shaped rechargeable battery, the shielding plate and the heat dissipating plate are arranged in a stack structure. The heat dissipating plate is heated by the heating element.

### BACKGROUND OF THE INVENTION

1. Field of the Invention

The present invention relates to a hand warmer that operates a heater by a battery.

2. Description of the Related Art

A hand warmer has been developed which includes a battery in a case to operate a heater and is disclosed in Japanese Laid-Open Publication No. H11-70137 (1999). FIG. 1 shows the hand warmer that is disclosed in Japanese Laid-Open Publication No. H11-70137 (1999). This hand warmer includes rechargeable batteries 91, a heating circuit 94 that has a heater 93, and a case 92. The heater 93 is supplied with current by the batteries 91, and generates heat. The case 92 accommodates the heating circuit 94. In this hand warmer, the cylindrical batteries 91 are accommodated and arranged in parallel to each other in the case 92, and supply current to the heater 93 that is accommodated in the case 92, thus the hand warmer generates heat.

The hand warmer disclosed in Japanese Laid-Open Publication No. H11-70137 (1999) cannot make effective use of the batteries to operate the heater for a long time. In addition, if a sufficient number of batteries are accommodated to use the hand warmer for a long time, the hand warmer becomes heavy as a whole. For this reason, there is a disadvantage in that the hand warmer cannot be conveniently used. It is important for hand warmers to be light in weight for sake of portability, and to be used at a predetermined amount of heat generation for a long time. Since the hand warmer that uses a battery as a power supply supplies electric power to a heater from the battery, it is important to efficiently use the battery to achieve this. In the hand warmer disclosed in Japanese Laid-Open Publication No. H11-70137 (1999), a plurality of the cylindrical batteries are accommodated in the case, and additionally the heater is also accommodated in the case. Since the thus-configured hand warmer generates heat from the interior of the case by means of the heater, the batteries are also heated. In particular, in the thus-configured hand warmer, the temperature inside the case becomes higher than the surface temperature of the case. Since, in the hand warmer, the surface temperature of the case is brought to temperature that warms user's hands and the like in cold winter, the interior of the case becomes considerably high temperature. Unfortunately, in nickel metal hydride batteries or nickel-cadmium batteries as the cylindrical batteries that are accommodated in the case, a temperature rise causes deterioration of their battery electrical property. For this reason, the heater deteriorates the battery property. Accordingly, the hand warmer disclosed in Japanese Laid-Open Publication No. H11-70137 (1999) has a disadvantage that cannot effectively operate the heater.

Also, since hand warmers are used in a cold season, they may be put in a low temperature environment before use. The battery electrical property deteriorates not only in high temperature conditions but also in low temperature conditions. In the case where a hand warmer that is put in a low temperature environment is used, if the temperature of its battery is low, the actual discharge capacity of the battery remarkably reduces. Accordingly, there is a disadvantage in that the heater cannot be effectively operated. This disadvantage can be avoided by warming the battery by the heater. However, in the hand warmer disclosed in Japanese Laid-Open Publication No. H11-70137 (1999), since the heater warms air inside the case, and thus warms the batteries through this air, it takes long time to rise the battery temperature. For this reason, in the case where the hand warmer is put in a very low temperature environment, the batteries may be fully discharged before warmed. Accordingly, there is a disadvantage in that the hand warmer cannot be used in such a case.

As stated above, the hand warmer disclosed in Japanese Laid-Open Publication No. H11-70137 (1999), since the batteries are subjected to a hostile temperature environment, the batteries cannot be efficiently discharged. For this reason, there is a disadvantage in that heating time by the heater becomes short in various environments.

The present invention has been developed for solving the disadvantages. It is an important object to provide a hand warmer that improves a battery temperature environment to be able to remarkably elongate its warming time.

Furthermore, it is another important object to provide a hand warmer that efficiently uses a battery to reduce the size and the weight of the hand warmer and thus to provide convenient portability.

### SUMMARY OF THE INVENTION

To achieve the aforementioned objects, a hand warmer according to the present invention is configured as follows.

The hand warmer according to the present invention includes a battery, a case, a heater, and a heat dissipating plate. The case accommodates the battery. The heater is supplied with current by the battery that is accommodated in the case and generates heat. The heat dissipating plate is thermally coupled to the heater. The battery is a box-shaped rechargeable battery of a box-shaped rechargeable lithium-ion battery or lithium-polymer battery that has flat surfaces opposed to each other. The heater is a heating element. The heating element is opposed to the flat surface of the battery. A shielding plate is arranged between the heating element and the flat surface of the battery. The heat dissipating plate that is formed of a metal plate is secured to the case on the surface side of the case, and is thermally coupled to the heating element to be heated. In the hand warmer, the flat surface of the box-shaped rechargeable battery, the shielding plate, the heating element, and the heat dissipating plate are arranged in a stack structure. The heat dissipating plate as the surface of the case is heated by the heating element.

The aforementioned hand warmer has a feature in that the battery temperature environment is improved so that warming time can be long. The reason is that, the hand warmer uses the battery for operating the heater that is a box-shaped rechargeable battery of a box-shaped rechargeable lithium-ion battery or lithium-polymer battery that has flat surfaces opposed to each other, and the heater that is a heating element that is opposed to the flat surface of the battery, in addition to this, a shielding plate is arranged between the heating element and the flat surface of the battery, and the heat dissipating plate that is formed of a metal plate that is thermally coupled to the heating element to be heated, and is secured to the case on the surface side of the case and. In the thus-configured hand warmer, the shielding plate is arranged between the heating element and the battery. Accordingly, the battery is not directly warmed when the heating element warms the heat dissipating plate. For this reason, the heating element efficiently warms the heat dissipating plate but does not heat the battery to high temperature. Therefore, it is possible to prevent a battery failure caused by temperature, and additionally to efficiently warm the heat dissipating plate by means of the heating element.

Furthermore, the aforementioned hand warmer reduces a battery failure caused by low temperature, and can be used for a long time even in a very cold environment. In the case where the hand warmer is put in a low temperature environment, the temperature of the battery becomes considerably low. Generally, the capacity of a battery that can substantially be discharged decreases as the battery temperature drops. However, the aforementioned hand warmer uses the box-shaped rechargeable battery as a battery and the heating element as a heater, and the shielding plate is arranged between the flat surface of the box-shaped battery and the heating element. In this configuration, the flat surface of the battery and heating element are arranged in a stack structure. In the hand warmer with this stack arrangement, the heat of the heating element is conducted to the battery via the shielding plate. For this reason, when the heating element is warmed by the battery, the battery is also quickly warmed by the heating element. Accordingly, it is possible to prevent a battery failure caused by low temperature. The shielding plate prevents that the heat of the heating element is directly conducted to the box-shaped battery, and as a result prevents that the temperature of the battery becomes high. The heat of the heating element is conducted to the flat surface of the box-shaped battery. Since the shielding plate does not conduct thermal energy much, the battery is not heated too much. However, in the case where the box-shaped battery has been put in a low temperature environment, the box-shaped battery is warmed by the heat conduction from the shielding plate, and a failure caused by low temperature is prevented. The heat of the heating element is thermally conducted to the box-shaped battery via the shielding plate. However, the opposite-side flat surface of the box-shaped battery is located in the exterior side in the case, and dissipates heat. For this reason, although heat is thermally conducted to the box-shaped battery from the shielding plate, the box-shaped battery is not heated to the high extent that a battery failure occurs. However, the box-shaped battery is warmed to the extent that a failure caused by low temperature is prevented.

Therefore, the aforementioned hand warmer prevents a battery failure caused by high and low temperature, and can effectively use the battery to efficiently operate the heating element. Furthermore, since the box-shaped rechargeable battery of rechargeable lithium-ion battery or lithium-polymer battery is used as a battery, the discharge capacity of the battery is high with respect to the volume of the battery. Therefore, it is possible to effectively operate the heating element for a long time. Consequently, the hand warmer according to the present invention efficiently uses the battery with a high capacity to be reduced in size and weight, and thus has a feature in that the hand warmer is conveniently carried.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view showing the internal structure of a known hand warmer;

FIG. 2 is a perspective view of a hand warmer according to one embodiment of the present invention;

FIG. 3 is a bottom view of the hand warmer shown in FIG. 2;

FIG. 4 is a vertical cross-sectional view of the hand warmer shown in FIG. 2;

FIG. 5 is a horizontal cross-sectional view of the hand warmer shown in FIG. 2;

FIG. 6 is an exploded perspective view of the hand warmer shown in FIG. 2 as viewed from the bottom surface side;

FIG. 7 is an exploded perspective view of the hand warmer shown in FIG. 2;

FIG. 8 is a block diagram of a hand warmer according to one embodiment of the present invention;

FIG. 9 is a vertical cross-sectional view of a hand warmer according to another embodiment of the present invention;

FIG. 10 is a horizontal cross-sectional view of the hand warmer shown in FIG. 9;

FIG. 11 is a vertical cross-sectional view of a hand warmer according to another embodiment of the present invention;

FIG. 12 is a side view of a hand warmer according to another embodiment of the present invention;

FIG. 13 is a side view of a hand warmer according to another embodiment of the present invention;

FIG. 14 is a graph showing the temperature property where a control circuit operates a heater;

FIG. 15 is a graph showing an example the control of a power switch by the control circuit based heater temperature and outside air temperature;

FIG. 16 is a vertical cross-sectional view of a hand warmer according to another embodiment of the present invention;

FIG. 17 is a side view of a hand warmer according to another embodiment of the present invention;

FIG. 18 is a circuit diagram of a hand warmer according to another embodiment of the present invention;

FIG. 19 is a side view showing the state where a charger mount charges the hand warmer shown in FIG. 18;

FIG. 20 is an exploded perspective view showing a hand warmer according to another embodiment of the present invention as viewed from the bottom surface side;

FIG. 21 is a vertical cross-sectional view including a partially enlarged view of the hand warmer shown in FIG. 20; and

FIG. 22 is a block diagram of the hand warmer shown in FIG. 20.

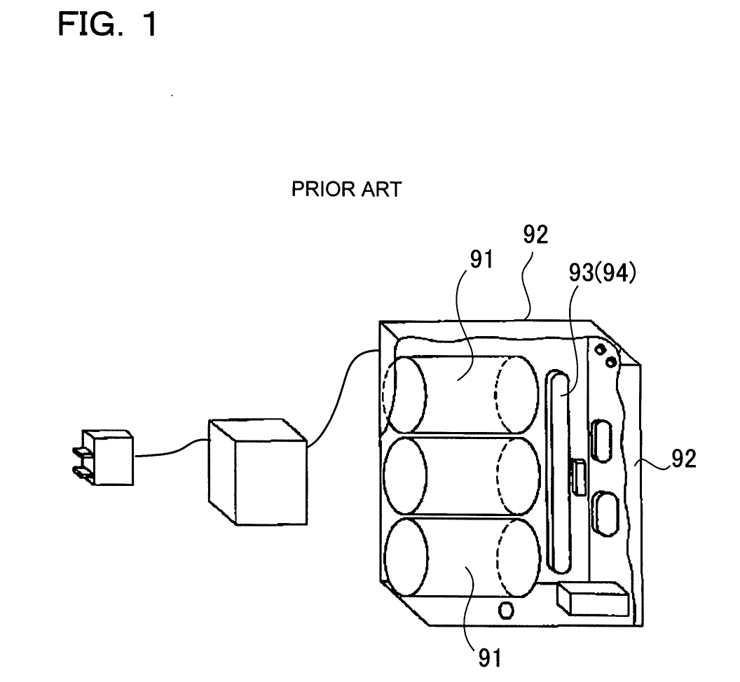

### DETAILED DESCRIPTION OF THE PREFERRED EMBODIMENT(S)

A hand warmer according to the present invention includes a battery, a case, a heater, and a heat dissipating plate. The case accommodates the battery. The heater is supplied with current by the battery that is accommodated in the case and generates heat. The heat dissipating plate is thermally coupled to the heater. The battery is a box-shaped rechargeable battery of a box-shaped rechargeable lithium-ion battery or lithium-polymer battery that has flat surfaces opposed to each other. The heater is a heating element. The heating element is opposed to the flat surface of the battery. A dividing plate is arranged between the heating element and the flat surface of the battery. The heat dissipating plate that is formed of a metal plate is secured as the surface of the case, and is thermally coupled to the heating element to be heated. In the hand warmer, a flat surface of the box-shaped rechargeable battery, the shielding plate, and the heat dissipating plate are arranged in a stack structure. The heat dissipating plate is heated by the heating element.

The heating element of the hand warmer can have a flat shape. In addition, in the hand warmer according to the present invention, the flat-shaped heating element can be arranged in parallel to the flat surface of the battery.

Note that, in this specification, the term “the flat-shaped heating element is arranged in parallel to the flat surface” is used in a broad sense to include the state where the flat-shaped heating element is arranged in the orientation that is slightly inclined relative to the flat surface.

In the thus-configured hand warmer, since the heating element of the hand warmer has a flat shape, the heating element is in contact in a large area with the heat dissipating plate, thus, the hand warmer has a feature that can efficiently warm the heat dissipating plate. In addition, the flat-shaped heating element can be in contact in a large area with the flat surface of the box-shaped battery, thus, the heat of the flat-shaped heating element is quickly conducted to the battery via the shielding plate. Accordingly, the hand warmer has a feature that can quickly heat the battery at low temperature.

In addition, in the hand warmer, the heating element of the hand warmer can be a flat-shaped PTC heater.

In the thus-configured hand warmer, since the heating element is a flat-shaped PTC heater, the temperature of the flat-shaped PTC heater can be controlled by the flat-shaped PTC heater itself. Accordingly, the hand warmer has a feature that can be safely used. The reason is that when the flat-shaped PTC heater is supplied with current, and the temperature of the flat-shaped PTC heater rises to a preset temperature value, the electrical resistance of the flat-shaped PTC heater rapidly rises so that the current is substantially cut off. The temperature of the hand warmer can be controlled not more than the preset temperature value by the flat-shaped PTC heater. Accordingly, the hand warmer can control the maximum temperature not more than the preset temperature value by a simple structure without using a control circuit that controls the temperature of the hand warmer.

In the hand warmer, the case can include first and second case members that are made of plastic and accommodate the box-shaped rechargeable battery. The second case member can be formed integrally with the shielding plate. The heat dissipating plate can be secured to the second case member on the surface side. In addition, in the hand warmer, while the box-shaped rechargeable battery can be arranged between the first case member and the shielding plate, the heating element can be arranged between the shielding plate and the heat dissipating plate.

In thus-configured the hand warmer, since the case includes the first and second case members that are made of plastic and accommodate the box-shaped rechargeable battery, in addition, the second case member is formed integrally with the shielding plate, and the heat dissipating plate is secured to the second case member on the surface side, and additionally the box-shaped rechargeable battery can be arranged between the first case member and the shielding plate, and the heating element can be arranged between the shielding plate and the heat dissipating plate, the shielding plate, and the heating element are arranged in a stack structure so as to eliminate wasted space. Therefore, the hand warmer also has a feature in that the hand warmer can be reduced in size, and can be easy assembled.

The hand warmer can include a control circuit that controls the electric power that is supplied from the box-shaped rechargeable battery to the heating element, and a temperature sensor that detects the temperature of the heat dissipating plate, in addition to this, the control circuit controls the supplied power to control the temperature of the heat dissipating plate.

In the thus-configured hand warmer, since the hand warmer includes the control circuit that controls the electric power that is supplied from the box-shaped rechargeable battery to the heating element, and the temperature sensor that detects the temperature of the heat dissipating plate, wherein the control circuit controls the supplied power to control the temperature of the heat dissipating plate, the hand warmer can control the temperature of the heating element and the heat dissipating plate by means of the control circuit, and can warm at the optimal temperature.

In the hand warmer, the control circuit can control the heat dissipating plate so that an early-stage preset temperature value of the heat dissipating plate is higher than a normal preset temperature value of the heat dissipating plate.

In thus-configured the hand warmer, since the control circuit control the heat dissipating plate so that the early-stage preset temperature value of the heat dissipating plate is higher than the normal preset temperature value of the heat dissipating plate, the hand warmer has a feature in that a user can quickly warms user's hands and the like by using the hand warmer in the state where a low temperature burn is prevented in the case of cold conditions, when the hand warmer is used to warm user's hands and the like.

In the hand warmer, the control circuit can include a switching element that is connected between the battery and the heating element, and a control portion that controls the switching element. The control portion can conduct the duty cycle control where the switching element is turned ON/OFF at a predetermined cycle period to control the temperature of the heat dissipating plate.

In the thus-configured control circuit, since the control circuit includes the switching element that is connected between the battery and the heating element and the control portion that controls the switching element, in addition to this, the control portion can conduct the duty cycle control where the switching element is turned ON/OFF at a predetermined cycle period to control the temperature of the heat dissipating plate, the hand warmer has a feature that has a high degree of flexibility of temperature control for the heating element and the heat dissipating plate.

In the hand warmer, an outside-air-temperature sensor can be arranged on the side opposed to the heating element to determine the not-in-use state of the hand warmer based on the detected temperature of the outside-air-temperature sensor so that power supply is turned OFF.

In the thus-configured hand warmer, since the outside-air-temperature sensor is arranged on the side opposed to the heating element to determine the not-in-use state of the hand warmer based on the detected temperature of the outside-air-temperature sensor so that power supply is turned OFF, the hand warmer has a feature that can prevent a waste of battery power consumption.

In the hand warmer, a vibrator that is driven by the battery can be accommodated in the case.

In the thus-configured hand warmer, since the vibrator that is driven by the battery is accommodated in the case, the hand warmer has a feature that can give massage by means of the vibrator while warming the heat dissipating plate to provide comfortable use.

The hand warmer can include a plurality of heating elements that have different preset temperature values. The heating elements can be selectively turned ON to be supplied with current to control the temperature of the heat dissipating plate.

In the thus-configured hand warmer, since the hand warmer include a plurality of the heating elements that have different preset temperature values, in addition to this, the heating elements are selectively turned ON to be supplied with current to control the temperature of the heat dissipating plate, the hand warmer has a feature in that the heating elements are selectively turned ON so that the temperature of the heat dissipating plate can be easily controlled.

In the hand warmer, the heating elements and the heat dissipating plates can be arranged on the both sides of the battery so that the shielding plates are interposed between the heating elements and the battery.

In the thus-configured hand warmer, since the heating elements and the heat dissipating plates are arranged on the both sides of the battery so that the shielding plates are interposed between the heating elements and the battery, the user can hold one hand warmer with user's both hands to warm user's both hands, for example.

In the hand warmer, the control circuit can include a memory that stores a preset temperature value. In addition to this, the hand warmer can include a USB connector that is connected to the control circuit. Additionally, the hand warmer can be connected to a computer via the USB connector, and the preset temperature value that is stored in the memory can be changed.

In the thus-configured hand warmer, since the control circuit includes the memory that stores a preset temperature value, in addition to this, the hand warmer includes the USB connector that is connected to the control circuit, and the hand warmer is connected to a computer via the USB connector, and the preset temperature value that is stored in the memory is changed, the hand warmer has a feature in that the user can use a computer to set the preset temperature value of the hand warmer to the optimum temperature value for the user.

In the hand warmer, a plurality of LEDs can be disposed in the case, and the control circuit can include a memory that stores the flashing state of the LEDs. In addition to this, the hand warmer can include a USB connector that is connected to the control circuit. Additionally, the hand warmer can be connected to a computer via the USB connector, and the flashing state of the LEDs that is stored in the memory can be changed.

In the thus-configured hand warmer, since the plurality of LEDs are disposed in the case, and the control circuit includes the memory that stores the flashing state of the LEDs, in addition to this, the hand warmer includes the USB connector that is connected to the control circuit, and the hand warmer is connected to a computer via the USB connector, and additionally the flashing state of the LEDs that is stored in the memory is changed, the user can set user's favorite flashing state of the LEDs.

In the hand warmer, the surface of the heat dissipating plate can be covered by an elastomer member. In the hand warmer, the flat-shaped PTC heater can be connected to the battery in series to serve as a protection circuit for the battery.

In the thus-configured hand warmer, since the surface of the heat dissipating plate is covered by the elastomer member, the elastomer member can prevent a low temperature burn, and can absorbs shock so that the drop resistance of the hand warmer is improved.

In the hand warmer in which the flat-shaped PTC heater is connected to the battery in series, since the flat-shaped PTC heater also serves as a protection circuit for the battery, the flat-shaped PTC heater can prevent that battery short circuit current flows.

In the hand warmer, the control circuit can include a temperature sensor that detects the temperature of the battery, and the heating element can pre-warm the battery when the battery temperature is lower than a preset temperature value.

In the thus-configured hand warmer, since the control circuit includes the temperature sensor that detects the temperature of the battery, in addition to this, the heating element pre-warms the battery when the battery temperature is lower than a preset temperature value, the hand warmer can prevent a battery failure caused by low temperature in the case where the hand warmer is put in a low temperature environment.

In the hand warmer, the battery can be a lithium-polymer battery, and the heat dissipating plate and the case can be deformable.

In the thus-configured hand warmer, since the battery is a lithium-polymer battery, and the heat dissipating plate and the case are deformable, the hand warmer can deform along the surface of user's body depending on a part of user's body where the hand warmer is used. Accordingly, the hand warmer has a feature that can provide comfortable use.

In the hand warmer, the case can accommodate a charging circuit for the battery. In addition to this, the charge circuit can include a no-contact charging circuit. Additionally, the charging circuit can be connected to a USB connector, and the battery can be charged via the USB connector. Still additionally, an AC plug can be disposed in the case and can be connected to the charging circuit, and the AC plug can be connected to an outlet to charge the battery.

In the thus configured hand warmer, since the case accommodates a charging circuit for the battery, it is possible to easily charge the battery that is accommodated in the case. In particular, in the case where the hand warmer includes a non-contact charging circuit, it is possible to charge the battery without connection by a connector or the like. Additionally, in the case where the charging circuit is connected to the USB connector, and the battery is charged via the USB connector, the battery can be charged via a USB connector or the like. Still additionally, in the case where the AC plug is disposed in the case and is connected to the charging circuit, and the AC plug is connected to an outlet to charge the battery, the battery can be charged via the AC plug that is connected to an outlet.

In the hand warmer, the heat dissipating plate can have a number of recessed and protruding parts on the surface of the heat dissipating plate.

In the thus-configured hand warmer, since the heat dissipating plate has a number of recessed and protruding parts on the surface of the heat dissipating plate, the hand warmer can prevent a low temperature burn.

In the hand warmer, the heat dissipating plate can have a flat portion on the interior side of the heat dissipating plate, and the flat portion can be thermally coupled to the heater.

In the thus-configured hand warmer, since the heat dissipating plate has a flat portion on the interior side of the heat dissipating plate, and the flat portion is thermally coupled to the heater, the heat of the heater can be effectively thermally conducted to the heat dissipating plate.

In the hand warmer, a metal plate can be arranged between the heat dissipating plate and the heater to supply current to the heater, and the metal plate can be in surface contact with and can be thermally coupled to the heat dissipating plate. In addition to this, the metal plate can be electrically connected to the heater via a protruding portion of the metal plate.

In the thus-configured hand warmer, since a metal plate is arranged between the heat dissipating plate and the heater to supply current to the heater, and the metal plate is in surface contact with and is thermally coupled to the heat dissipating plate, the hand warmer has a feature in that the temperature variation of the heat dissipating plate can be reduced with respect to the temperature variation of the heater. In particular, in thus-configured hand warmer, since the metal plate is electrically connected to the heater via a protruding portion that is included in the metal plate, it is possible to ensure electrical connection between the metal plate and the heater.

In the hand warmer, the hand warmer can include an emergency alarm that is supplied with electric power from the battery that supplies current to the heater. In addition to this, the hand warmer can include a control portion that detects the remaining capacity or voltage of the battery, and cuts off current for the heater and supplies electric power only to the emergency alarm when the remaining capacity or voltage becomes smaller than a predetermined value.

In the thus-configured hand warmer, the hand warmer includes an emergency alarm that is supplied with electric power from the battery that supplies current to the heater. In the case where the hand warmer includes the emergency alarm, since the user normally carries the hand warmer in the state where the user holds the hand warmer with user's hand, or carries the hand warmer in user's pocket, the user can quickly operate the emergency alarm in emergency when walking at night in winter, for example.

In addition, in the hand warmer, since the remaining capacity or voltage of the battery is detected so that current for the heater is cut off and electric power is supplied only to the emergency alarm when the remaining capacity or voltage becomes smaller than a predetermined value, the battery is prevented from running down in emergency. Therefore, it is possible to surely operate the emergency alarm.

A hand warmer includes a battery; a case that accommodates the battery; a heater that is supplied with current to generate heat by the battery that is accommodated in the case; and a heat dissipating plate that is thermally coupled to the heater, in addition to this, the battery is a box-shaped rechargeable battery of a box-shaped rechargeable lithium-ion battery or lithium-polymer battery that has flat surfaces opposed to each other, and the heater is a flat-shaped heating element that is opposed to the flat surface of the battery, additionally the heat dissipating plate that is formed of a metal plate is secured to the case on the surface side of the case, and is thermally coupled to the heating element to be heated, and the heating element heats the heat dissipating plate as the surface of the case.

In the thus-configured hand warmer, since the box-shaped rechargeable battery, the heating element as the flat-shaped heater, and the heat dissipating plate are disposed, the hand warmer is reduced in size and weight, and thus provides convenient portability.

In addition, the hand warmer further includes a control portion that detects the remaining capacity of the battery, a power switch that is disposed in the case and turns power supply ON/OFF, and an LED that is disposed in the case and can emit light in previously set different flashing patterns in accordance with the remaining capacity of the battery. In addition to this, in the hand warmer, when the power switch is turned OFF, the control portion detects the remaining capacity of the battery, and controls so that the LED emits light in different flashing patterns in accordance with the detected remaining capacity of the battery. Accordingly, when turning the power switch of the hand warmer OFF, the user can check the remaining capacity of the battery based on the LED flashing pattern at that time.

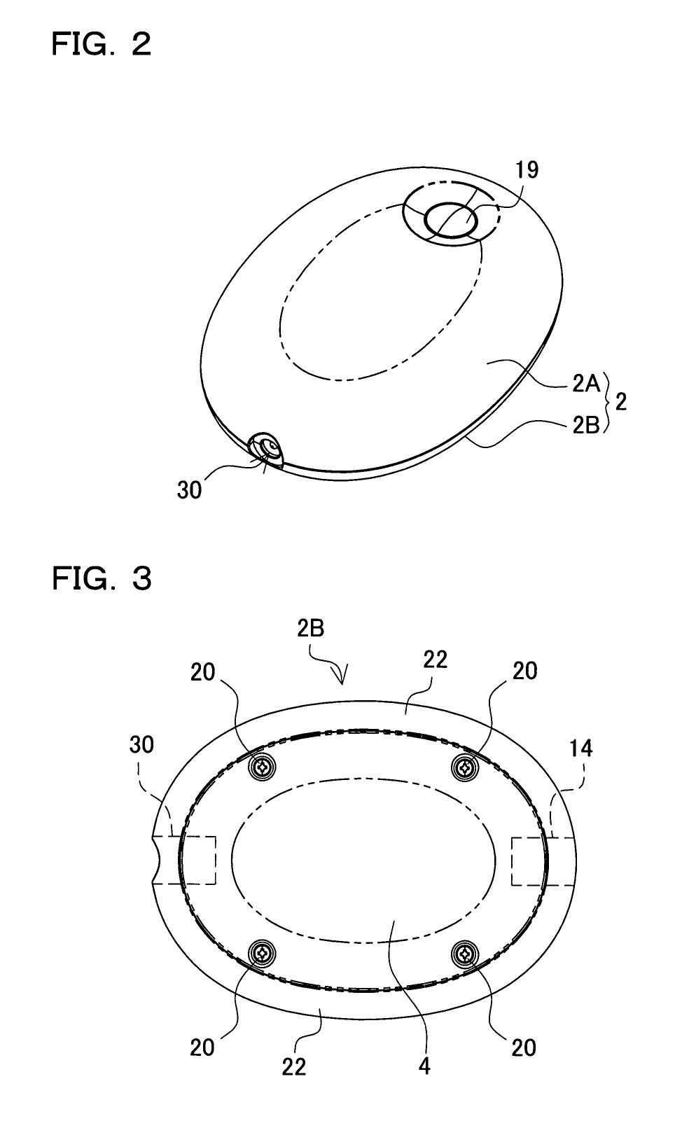

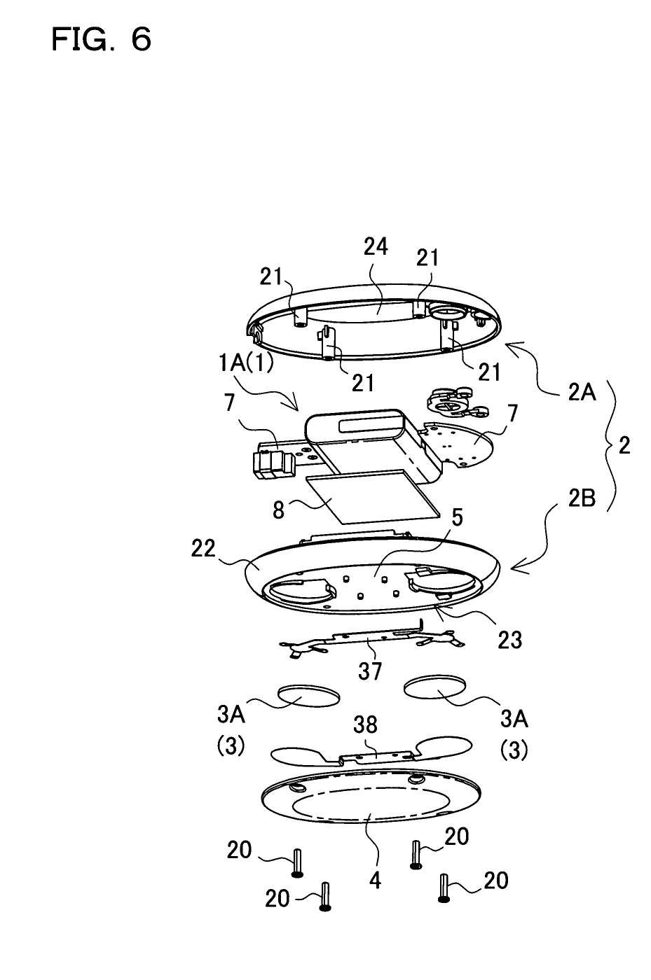

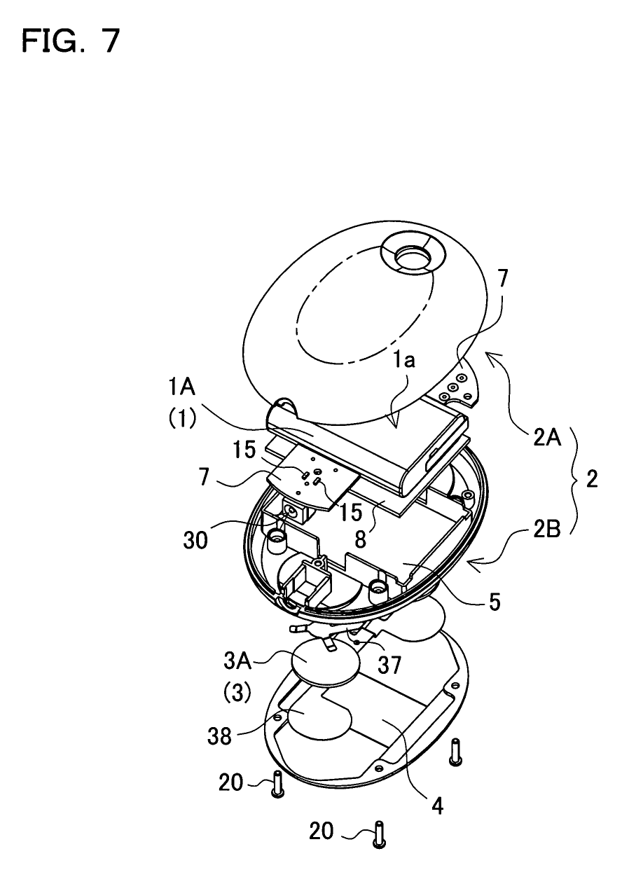

A hand warmer shown in FIGS. 2 to 8 includes a battery 1, a case 2, heaters 3, a heat dissipating plate 4, and a control circuit 6. The case 2 accommodates the battery 1. The heaters 3 as a heating element are supplied with current by the battery 1 that is accommodated in the case 2. The heat dissipating plate 4 is thermally coupled to the heaters 3. The control circuit 6 controls the electric power that is supplied to the heaters 3. The heater 3 is the flat-shaped PTC heater 3A. An element that uses heat generated by a transistor, resistor, and the like can be used as the heating element other than the flat-shaped PTC heater 3A,.

The battery 1 is a box-shaped rechargeable battery 1A of a box-shaped rechargeable lithium-ion battery or lithium-polymer battery that has flat surfaces 1a opposed to each other. The box-shaped rechargeable battery 1A is composed of an exterior case that is formed by stamping aluminum or aluminum alloy into a box shape, and hermetically accommodates electrodes and an electrolytic solution. In the box-shaped rechargeable battery 1A, the electrodes tightly contact the interior side of the flat surface 1a of the exterior case. For this configuration, in winter cold conditions, the electrodes are warmed to a certain temperature value via the flat surface 1a of the exterior case, and therefore it is possible to quickly improve the electrical property in the case of low temperature. The box-shaped rechargeable battery 1A is a rechargeable lithium-ion battery with voltage of 3.7V and capacity of 2000 mAh. The battery 1 can operate the flat-shaped PTC heaters 3A for approximately 8 to 10 hours in the case where the heat dissipating plate 4 is warmed at 42° to 46° C. by the flat-shaped PTC heaters 3A. Note that a lithium-polymer battery can be also used as the battery.

The case 2 has an oval shape in a plan view as a whole. Also, the case 2 has a thin oval shape in a cross-sectional view. The case 2 is made of plastic. The case 2 is composed of the first and second case members 2A and 2B that are made of plastic and accommodate the box-shaped rechargeable battery 1A. The second case member 2B is formed integrally with a shielding plate 5.

The first case member 2A is configured to have the size that accommodates the box-shaped rechargeable battery 1A and a circuit board 7 on which the electronic components of the control circuit 6 are mounted. In addition, the first case member 2A is formed integrally with connecting ribs 21 that threadedly receive locking screws that fasten the second case member 2B. The connecting ribs 21 are formed at the four corners of the box-shaped rechargeable battery 1A.

The second case member 2B has a peripheral wall 22 around the shielding plate 5. The heat dissipating plate 4 is secured to the peripheral wall 22. The shielding plate 5 closes an opening of the first case member 2A that accommodates the box-shaped rechargeable battery 1A. The shielding plate 5 is configured to have a plate shape that extends along the flat surface 1a of the box-shaped rechargeable battery 1A. An adjustment sheet 8 is arranged between the shielding plate 5 and the flat surface 1a of the box-shaped rechargeable battery 1A to control heat conduction. Accordingly, it is possible to control the heat conduction between the flat-shaped PTC heaters 3A as the heaters 3 and the box-shaped rechargeable battery 1A. A sheet with small thermal conductivity is used for the adjustment sheet 8. Accordingly, it is possible to reduce heat conduction between the flat-shaped PTC heaters 3A and the box-shaped rechargeable battery 1A. The heat conduction between the flat-shaped PTC heaters 3A and the box-shaped rechargeable battery 1A can be also controlled by the thickness and the thermal conductivity of the shielding plate 5.

The heat dissipating plate 4 is secured around the lower end periphery of the peripheral wall 22 of the second case member 2B so that the heat dissipating plate 4 is arranged on the surface side of the case 2. The heat dissipating plate 4 closes an opening of the peripheral wall 22 that is arranged as the exterior side of the second case member 2B. The opening of the peripheral wall 22 has a shape that fits to the outside shape of the heat dissipating plate 4. In addition, the peripheral wall 22 has a stepped portion 23 that extends along the lower end periphery of the peripheral wall 22. The outside periphery of the heat dissipating plate 4 is fitted into the stepped portion 23. The upper end periphery of the peripheral wall 22 of the second case member 2B is configured to have a shape that is connected to the outside periphery of the first case member 2A. In the state where the heat dissipating plate 4 is secured to the second case member 2B, the flat-shaped PTC heater 3A is arranged between the shielding plate 5 and the heat dissipating plate 4. This arrangement provides the stack structure where the flat surface 1a of the box-shaped rechargeable battery 1A, the shielding plate 5, the flat-shaped PTC heater 3A, and the heat dissipating plate 4 are stacked. The box-shaped rechargeable battery 1A is arranged between a bottom plate 24 of the first case member 2A and the shielding plate 5. The flat-shaped PTC heater 3A is arranged between the shielding plate 5 and the heat dissipating plate 4, and directly heats the heat dissipating plate 4 and warms the box-shaped rechargeable battery 1A via the shielding plate 5.

The flat-shaped PTC heaters 3A have a substantially disk shape. The flat-shaped PTC heaters 3A are arranged to be opposed to the flat surface 1a of the box-shaped rechargeable battery 1A under the lower surface of the shielding plate 5 of the second case member 2B in the orientation parallel to the flat surface 1a. The heat dissipating plate 4 is secured to be thermally coupled to the flat-shaped PTC heaters 3A so that the flat-shaped PTC heaters 3A warm the heat dissipating plate 4. When the flat-shaped PTC heaters 3A are supplied with current, and the temperature of the flat-shaped PTC heaters 3A rises to a preset temperature value, the electrical resistance of the flat-shaped PTC heaters 3A rapidly rises so that the current is substantially cut off. Accordingly, the flat-shaped PTC heaters 3A serve to control their temperature not higher than the preset temperature value by itself. Therefore, it is possible to set the maximum temperature value not higher than the preset temperature value without using a control circuit that controls the temperature. Alternatively, the temperature of the flat-shaped PTC heaters 3A can be controlled by controlling the current that is supplied to the flat-shaped PTC heaters 3A. Silver-plated electrodes are formed on the both surfaces of the flat-shaped PTC heater 3A. The surfaces of the electrodes are in press contact with metal plates 37 and 38. Thus, the flat-shaped PTC heater 3A is supplied with electric power. Although the detailed description of the metal plates 37 and 38 is omitted, the metal plate 37 is configured to have a bent part that extends and passes through the shielding plate 5 to be electrically connected to the circuit board 7.

The illustrated hand warmer includes a plurality of the flat-shaped PTC heaters 3A. The plurality of flat-shaped PTC heaters 3A that are included in the hand warmer have the same preset temperature value, or different preset temperature values. In the case where the hand warmer includes the flat-shaped PTC heaters 3A with different preset temperature values, the hand warmer controls ON/OFF switching of the flat-shaped PTC heaters 3A to be supplied with current, and can control the temperature of the heat dissipating plate 4. In the case where the hand warmer includes two flat-shaped PTC heaters 3A, for example, one flat-shaped PTC heater 3A can have a preset temperature value of 45° C., and another flat-shaped PTC heater 3A can have a preset temperature value of 48° C. The hand warmer can warms the heat dissipating plate 4 to 45° C. by supplying current to the flat-shaped PTC heater 3A with the preset temperature value of 45° C. Also, the hand warmer can warms the heat dissipating plate 4 to 48° C. by supplying current to the flat-shaped PTC heater 3A with the preset temperature value of 48° C. In addition, the hand warmer can quickly warms the heat dissipating plate 4 to 48° C. by supplying current to both the flat-shaped PTC heaters 3A.

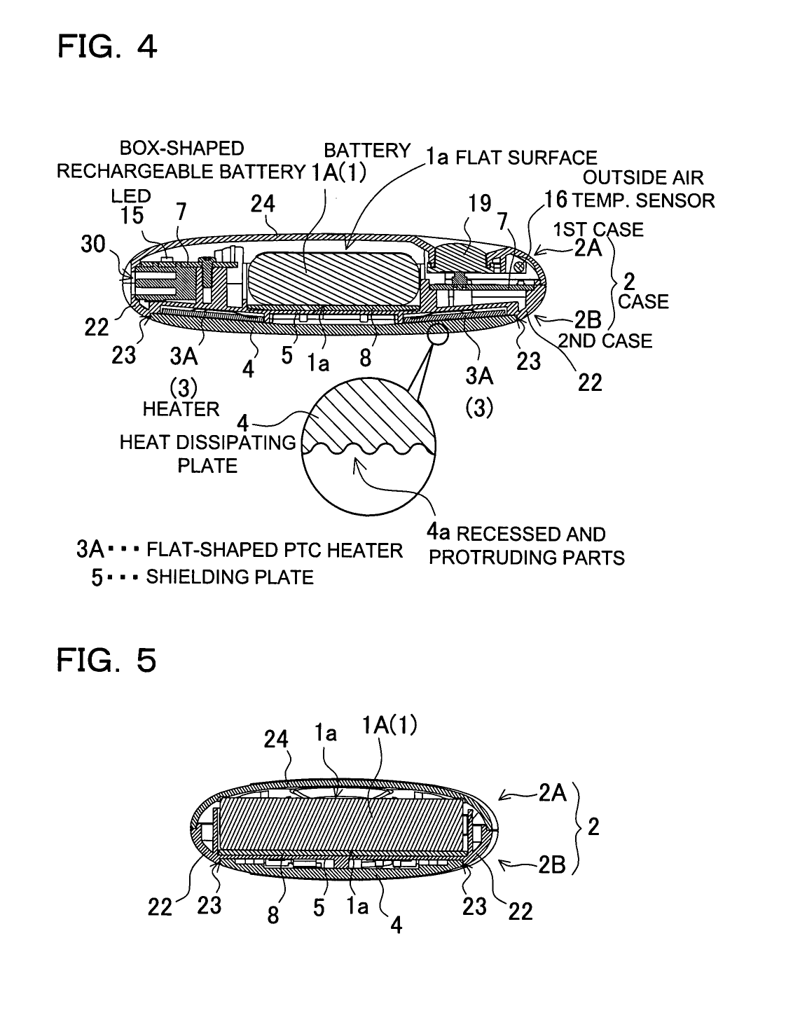

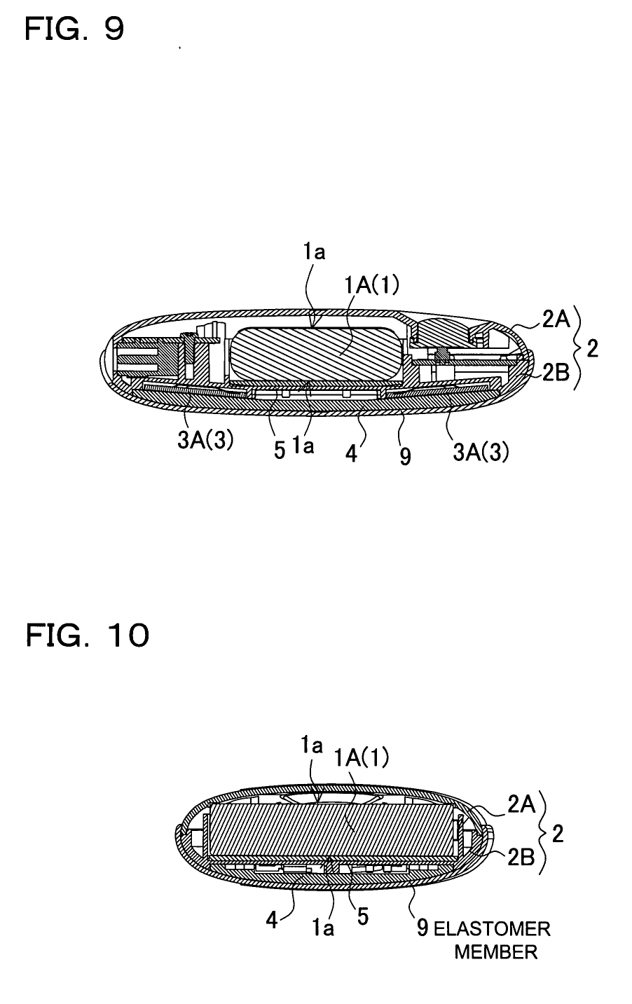

The heat dissipating plate 4 is made of an excellent heat conductive metal plate such as aluminum and copper. As shown in partially enlarged view in FIG. 4, the heat dissipating plate 4 has a number of recessed and protruding parts 4a on its surface, and therefore it is possible to prevent a low temperature burn. The reason is that the heat dissipating plate 4 with the recessed and protruding parts 4a is not in intimate surface contact with human skin. Alternatively, as shown in FIGS. 9 and 10, an elastomer member 9 can cover the surface of the heat dissipating plate 4 to prevent a low temperature burn. In addition to this, in the hand warmer with the elastomer member 9 that covers the periphery of the case 2 as shown in FIGS. 9 and 10, the elastomer member 9 absorbs shock and the like when the hand warmer falls. Therefore, it is possible to improve shock resistance.

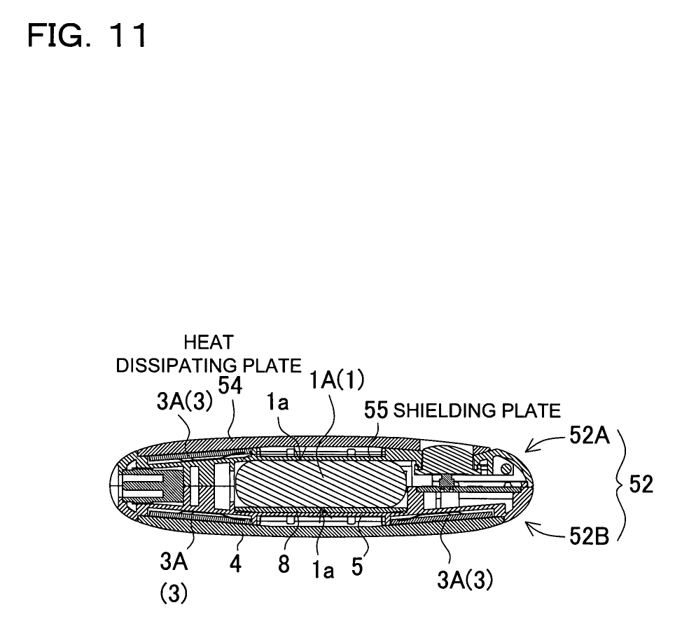

Alternatively, as shown in FIG. 11, the hand warmer can include the flat-shaped PTC heaters 3A, and heat dissipating plates 4 and 54 on the both sides of the box-shaped rechargeable battery 1A. The shielding plates 5 and 55 are interposed between the flat-shaped PTC heaters 3A and the surfaces of the box-shaped rechargeable battery 1A. In the illustrated hand warmer, first and second case members 52A and 52B that composes a case 52 are formed integrally with the shielding plates 55 and 5, and the box-shaped rechargeable battery 1A is arranged between a pair of the shielding plates 55 and 5. That is, in the case 52, the box-shaped battery 1A is sandwiched between the shielding plate 55 of the first case member 52A and the shielding plate 5 of the second case member 52B from the both sides of the box-shaped battery 1A. Thus, the shielding plates 55 and 5 are arranged on both the flat surfaces 1a of the box-shaped rechargeable battery 1A, respectively. In the case 52, the heat dissipating plates 54 and 4 are secured to the first and second case members 52A and 52B on the surface sides, respectively. In the illustrated hand warmer, in the state where the heat dissipating plate 54 is secured to the first case member 52A, and the heat dissipating plate 4 is secured to the second case member 2B, the flat-shaped PTC heaters 3A are arranged between the shielding plates 55 and 5, and the heat dissipating plates 54 and 4, respectively. In this arrangement, the shielding plates 55 and 5, the flat-shaped PTC heaters 3A, and the heat dissipating plates 54 and 4 are arranged in a stack structure on both the flat surfaces 1a of the box-shaped rechargeable battery 1A. The heat dissipating plates 54 and 4 are arranged on the back and front surfaces of the hand warmer. This hand warmer has a feature in that both the back and front surfaces can warm user's hands or the like.

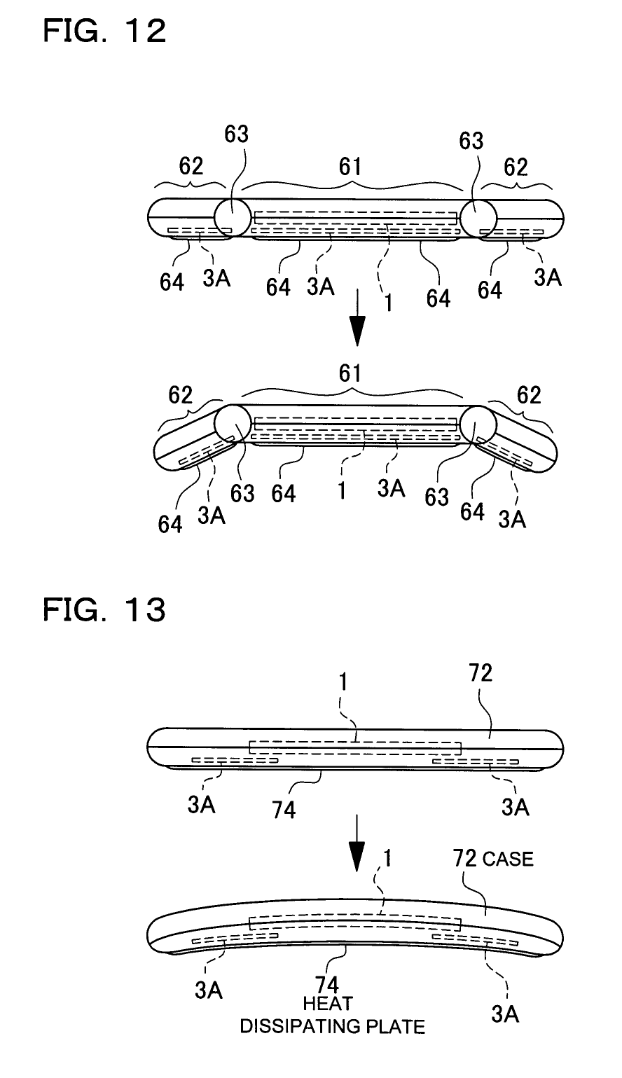

Alternatively, the hand warmer can have a deformable structure where the hand warmer can deform as a whole as shown in FIGS. 12 and 13. The hand warmer shown in FIG. 12 includes swing portions 62 on the both sides of a main portion 61. The swing portions 62 can swing about connecting portions 63. The main portion 61 and the swing portions 62 are swingably connected via the connecting portions 63. Examples of the connecting portion 63 can be provided by various mechanisms, such as a hinge, a ball-and-socket joint, and a shaft-and-bearing mechanism. In the illustrated hand warmer, the main portion 61 accommodates the battery 1, and the flat-shaped PTC heaters 3A as the heating elements are arranged in the main part portion 61 and the swing portions 62. The main part portion 61 and the swing portions 62 accommodate the heat dissipating plates 64 of metal plates on the lower surfaces of the main part portion 61 and the swing portions 62 that are opposed to the flat-shaped PTC heaters 3A. Since the thus-configured hand warmer can deform depending on a part of user's body where the hand warmer is used, this hand warmer has a feature that can provide comfortable use. The whole part of the illustrated hand warmer is divided into three parts of the main portion 61 and the swing portions 62 on the both sides so that the three parts can swing relative to each other about two axes. However, although not illustrated, the whole part of the hand warmer can be divided into two parts so that so that the two parts can swing relative to each other about one axis.

Alternatively, the hand warmer shown in FIG. 13 has a deformable structure where the hand warmer can be bent as a whole. In the illustrated hand warmer, a lithium-polymer battery is used as the battery 1 that is accommodated in a case 72, and the case 72 is formed of a flexible elastic material that can be curved or bent. Examples of the elastic material can be provided by nonrigid plastic, rubber, and the like. In addition, a metal plate or a metal foil is secured to the case 72 on the surface side of the case 72 as a heat dissipating plate 74. The metal plate or the metal foil has thickness to the extent that the metal plate or the metal foil can be curved. The thus-configured hand warmer can be curved along the shape of a cold part of user's body. Therefore, the hand warmer has a feature that can provide comfortable use. Furthermore, the case 72 that is formed of an elastic material component has a feature that can provide better feeling in touch.

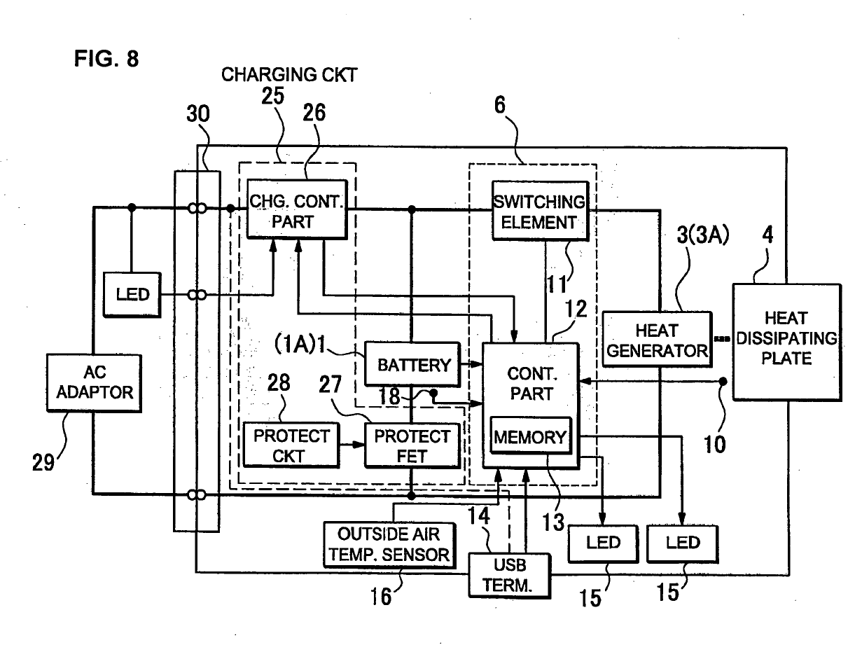

FIG. 8 shows a circuit diagram of the hand warmer. The hand warmer shown in this circuit diagram includes the control circuit 6, and the temperature sensor 10. The control circuit 10 controls the electric power that is supplied from the box-shaped rechargeable battery 1A as the battery 1 to the flat-shaped PTC heater 3A as the heating element. The temperature sensor 10 detects the temperature of the heat dissipating plate 4. The control circuit 6 controls the power that is supplied to the flat-shaped PTC heater 3A, and controls the temperature of the flat-shaped PTC heater 3A, i.e., the temperature of the heat dissipating plate 4.

The control circuit 6 includes a switching element 11, and a control portion 12. The switching element 11 is connected between the battery 1 and the flat-shaped PTC heater 3A. The control portion 12 includes a microcomputer that controls ON/OFF of the switching element 11. In the hand warmer, since the flat-shaped PTC heater 3A is connected to the battery 1 in series via the switching element 11, the flat-shaped PTC heater 3A also serves as a protection circuit for the battery 1. The reason is that, even if the switching element 11 is held in ON state caused by internal short circuit or the melting of the switching element 11, for example, the electrical resistance of the flat-shaped PTC heater 3A rapidly increases when the temperature of the flat-shaped PTC heater 3A reaching the preset temperature value so that the current is substantially cut off to protect the battery 1.

8 The control portion 12 conducts the duty cycle control where the switching element 11 is turned ON/OFF at a predetermined cycle period to control the temperature of the heat dissipating plate 4. When turning the switching element 11 ON at a long period, the control portion 12 can set the temperature of the flat-shaped PTC heater 3A high, that is, can set the temperature of the heat dissipating plate 4 high. Conversely, when turning the switching element 11 ON at a short period, the control portion 12 can set the temperature of the flat-shaped PTC heater 3A and the heat dissipating plate 4 low. The control portion 12 may conduct the duty cycle control of the switching element 11 based on a signal that is provided from the temperature sensor 10 that detects the temperature of the heat dissipating plate 4 to bring the flat-shaped PTC heater 3A and the heat dissipating plate 4 to the preset temperature value.

A memory 13 is installed in the control portion 12 of the control circuit 6 to store the preset temperature value. The control portion 12 conducts the duty cycle control where the switching element 11 is turned ON/OFF to bring the flat-shaped PTC heater 3A to the preset temperature value that is stored by the memory 13. The control portion 12 does not necessarily conduct the duty cycle control where the switching element 11 is turned ON/OFF at a predetermined cycle period to control the temperature. The control portion 12 may conduct control based on the signal that is provided from the temperature sensor 10 so that when the flat-shaped PTC heater 3A is brought higher than the preset temperature value the switching element 11 is turned OFF, and when the flat-shaped PTC heater 3A is brought lower than the preset temperature value the switching element 11 is turned ON, which in turn maintains the flat-shaped PTC heater 3A at the preset temperature value.

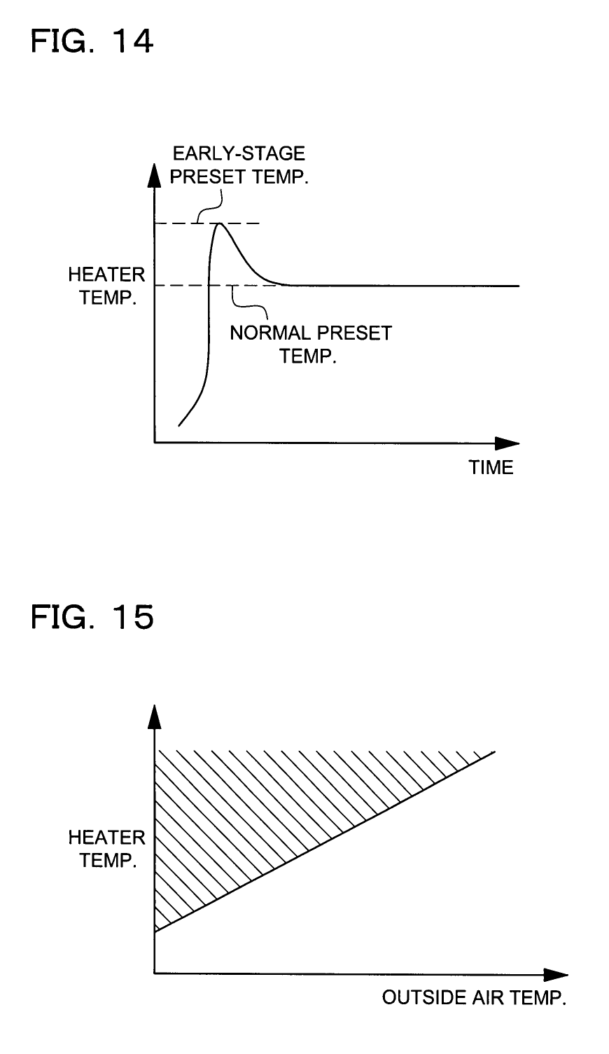

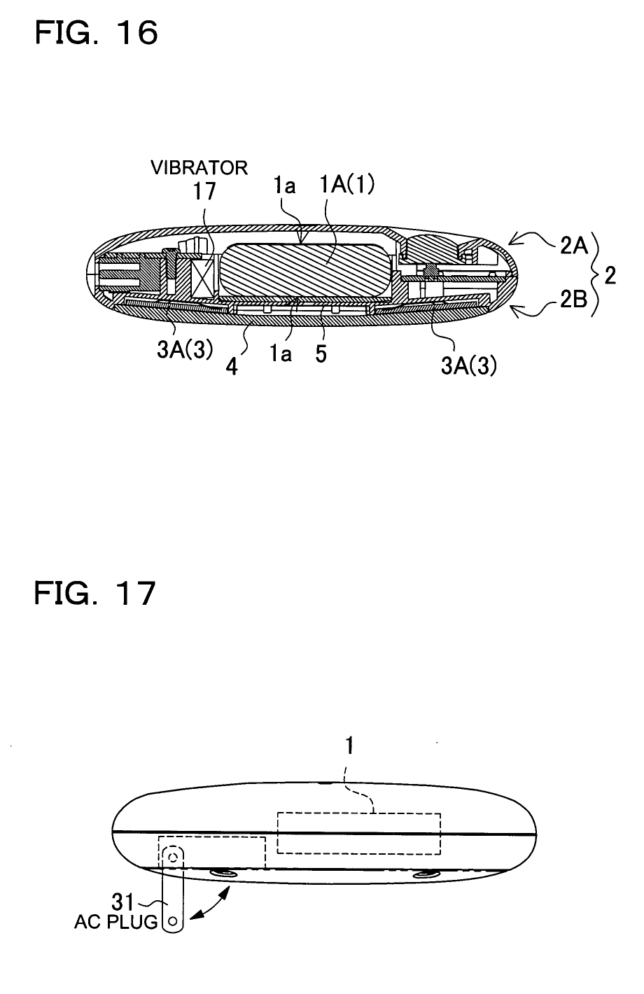

The memory 13 of the control circuit 6 stores an early-stage preset temperature value and a normal preset temperature value. The early-stage preset temperature value is set higher than the normal preset temperature value. As shown in FIG. 14, the control circuit 6 warms the flat-shaped PTC heater 3A to the early-stage preset temperature value in the early stage after a power switch 19 of the hand warmer is turned ON, and then controls to bring the flat-shaped PTC heater 3A to the normal preset temperature value. The hand warmer that thus warms the flat-shaped PTC heater 3A and the heat dissipating plate 4 to achieve this temperature curve quickly becomes warm within a short time, and can quickly warm user's hands and the like when the user is cold. After being brought to the early-stage preset temperature value, since the flat-shaped PTC heater 3A is maintained at the normal preset temperature value, the average current of the flat-shaped PTC heater 3A can be reduced, and as a result the hand warmer can be used for a long time.

In the control circuit 6 shown in FIG. 8, a USB connector 14 is connected to the control portion 12. The USB connector 14 is located in the case 2 as shown by a dashed line in FIG. 3. The USB connector 14 is connected to a computer. The control circuit 6 is connected to the computer via the USB connector 14. The preset temperature value stored in the memory 13 can be changed. The hand warmer is connected to the computer, and as a result the user can change the preset temperature value to optimize the temperature of the heat dissipating plate for the user.

In the hand warmer shown in FIG. 8, a plurality of LEDs 15 are connected to the control circuit 6. The LEDs 15 are fastened to the circuit board 7 that is accommodated in the case 2, and the flashing state of the LEDs 15 is controlled by the control circuit 6. In the illustrated hand warmer, the first case member 2A that is located above the LEDs 15 is made of transparent plastic. Light from the LEDs 15 passes through the case 2 without openings that expose the LEDs 15. Accordingly, the LEDs 15 is visible to the outside of the case 2. Note that the case may have openings that expose the LEDs so that the LEDs 15 is visible to the outside of the case. The control circuit 6 stores flashing patterns that flash the LED 15 ON/OFF in the memory 13 of the control portion 12. The flashing patterns of the LED 15 that are stored in the memory 13 of the control portion 12 are changed by the computer that is connected via the USB connector 14. The user can control the flashing state of the LEDs 15 by using the computer that is connected to the hand warmer to change the flashing patterns to user's favorite patterns.

One or more LEDs can be disposed in the case 2. The LED flashing patterns can be changed in accordance with the remaining capacity of the battery 1. That is, the remaining capacity indication flashing patterns can be previously set in accordance with the remaining capacity when the LED is flashed at predetermined timing so that the user can know the remaining capacity of the battery of the hand warmer based on the LED flashing patterns. As for predetermined timing, the LED can be flashed when the power switch 19 is turned ON or OFF, or when the power switch 19 is kept being pressed for predetermined seconds or more, for example. In particular, the LED is preferably flashed in the remaining capacity indication flashing patterns when the power switch 19 is turned OFF. This configuration can inform to the user that it is necessary to charge the battery if the remaining capacity of the battery is small. Therefore, it is possible to urge the user to charge the battery so that the user can immediately use the hand warmer in next use. In this case, the power switch also serves as a switch for flashing the LED in the remaining capacity indication flashing patterns. Therefore, it is possible to reduce a parts count.

The remaining capacity indication flashing patterns can be provided by the flashing number or the flashing period of the LED, the flashing color of LED, or combination of them. In exemplary remaining capacity indication flashing patterns, when the power switch is turned OFF, the LED 15 of a green LED stays illuminated or is flashed ON and OFF for three seconds. As an instance, when the remaining capacity of the battery is not more than 40%, the LED 15 is stays illuminated in green for three seconds to show that it is not necessary to charge the battery. When the remaining capacity of the battery is between 40% and 70%, the LED 15 is flashed in green ON and OFF at long intervals (e.g., at intervals of one second for three seconds) to show that the hand warmer is available. When the remaining capacity of the battery is not more than 40%, the LED 15 is flashed in green ON and OFF at short intervals (e.g., at intervals of 0.5 second for three seconds) to show that it is necessary to charge the battery. Although the LED 15 emits in one color in the above instance, the LED 15 can emit in a plurality of colors. As another instance, when the remaining capacity of the battery is not less than 70%, the LED stays illuminated in green for five seconds. When the remaining capacity of the battery is between 40% and 70%, the LED is flashed ON and OFF in yellow for five seconds. When the remaining capacity of the battery is not more than 40%, the LED is flashed ON and OFF in red for eight seconds, for example. In particular, when the remaining capacity is low, it is preferable to combine red light, short-period flashing, and the like that effectively call attention. These remaining capacity indication flashing patterns are controlled by the control portion 12 that detects the remaining capacity of the battery. The remaining capacity of the battery is detected through measuring the voltage of the battery 1 by the control portion 12. Besides that the remaining capacity indication flashing patterns are previously set, the user may change the remaining capacity indication flashing patterns by a computer that is connected to the hand warmer via the USB terminal 14 as stated above. The remaining capacity indication flashing patterns are stored in the memory 13. In the case where the LED flashing colors are switched, needless to say, the hand warmer can include one or more LEDs each of which can selectively emit light in different colors, or a plurality of LEDs that emit light in colors different to other LED.

In order to determine the state where the hand warmer is not used, the control circuit 6 shown in FIG. 8 is connected to the outside-air-temperature sensor 16 that is arranged on the side opposite to the flat-shaped PTC heater 3A as shown in FIG. 4. The hand warmer determines the state where the hand warmer is not used, that is, the not-in-use state, based on the detected temperature that is detected by the outside-air-temperature sensor 16 as the outside air temperature to turn the power switch 19 OFF. In this case, an opening may be arranged on the first case member 2A in proximity to the outside-air-temperature sensor 16 to guide the outside air to the outside-air-temperature sensor 16.

The control circuit 6 determines the not-in-use state based on the temperature of the flat-shaped PTC heater 3A and the signal from the outside-air-temperature sensor 16, and turns the power switch 19 OFF. FIG. 15 shows a hatched area where the power switch 19 is turned OFF. In the case where the temperature of the flat-shaped PTC heater 3A and outside air temperature correspond to the hatched area in this Figure, the control circuit 6 turns the power switch 19 OFF. Since the hatched area corresponds to the state where the temperature of the flat-shaped PTC heater 3A is higher than the outside air temperature, in other words, the state where the detected temperature of the outside-air-temperature sensor 16 is low, that is, the state where the hand warmer is not put inside clothing, the hatched area is determined as the not-in-used state. In the hand warmer, the power switch 19 is automatically turned OFF when the hand warmer is not in use. Therefore, it is possible to eliminate wasted power consumption of the battery 1.

In the hand warmer shown in FIG. 13, the case 2 accommodates the vibrator 17 that is driven by the battery 1. The hand warmer has a feature that can massage user's body while warming the heat dissipating plate 4. Also, the hand warmer can massage user's body in the state where the heat dissipating plate 4 is not warmed. The control portion 12 can activate the vibrator 17 to vibrate periodically (approximately 20 seconds for one activation every ten minutes to every one hour) during the hand warmer operation to inform the user that the hand warmer is in operation.

In the hand warmer of FIG. 4, the shielding plate 5 is arranged along the flat surface 1a of the battery 1, additionally, the flat-shaped PTC heaters 3A are arranged in parallel to the lower surface of the shielding plate 5 under the lower surface of the shielding plate 5. That is, the flat surface 1a of the battery 1, the shielding plate 5, and the flat-shaped PTC heater 3A are arranged in a stack structure in the parallel orientation. In the thus-configured hand warmer, the heat of the flat-shaped PTC heaters 3A can be conducted to the battery 1 via the shielding plate 5. Since the heat of the flat-shaped PTC heaters 3A is not directly conducted to the battery 1, the battery 1 is not heated by the flat-shaped PTC heater 3A. However, a part of heat that is generated by the flat-shaped PTC heaters 3A is indirectly conducted to the battery 1 via the shielding plate 5. In a very low temperature environment, in the hand warmer, the flat-shaped PTC heaters 3A are supplied with current to pre-warm the battery 1. In the hand warmer, as shown in FIG. 8, the control portion 12 is connected to a temperature sensor 18 that detects the temperature of the battery 1. If the temperature sensor 18 detects that the battery temperature is lower than a preset temperature value, the control portion 12 turns the switching element 11 ON, and the flat-shaped PTC heater 3A pre-warms the battery 1. In this case, the control portion 12 conducts the duty cycle control where the switching element 11 is turned ON/OFF, and controls the temperature of the flat-shaped PTC heaters 3A so as to adjust the temperature of the flat-shaped PTC heaters 3A for warming the battery 1. It is not necessary to warm the battery 1 to high temperature that is required for the heat dissipating plate 4. For this reason, in order to pre-warm the battery 1, the duty cycle control is conducted so that the switching element 11 is turned ON at a short cycle period. As a result, power consumption of the battery 1 is suppressed.

The hand warmer shown FIG. 8 includes a charging circuit 25 for the battery 1 in the case 2. The charging circuit 25 is mounted on the circuit board 7 that is accommodated in the case 2. The charging circuit 25 includes a charge control portion 26 that charges a rechargeable lithium-ion battery or a lithium-polymer battery as the box-shaped rechargeable battery 1A. The charge control portion 26 charges the box-shaped rechargeable battery 1A in a constant-current and constant-voltage manner, and detects the full charged state and then stops the charging operation. In addition, the illustrated charge circuit 25 includes a protection FET 27 that is connected to the box-shaped rechargeable battery 1A in series, and controls the protection FET 27 by means of a protection circuit 28. The protection circuit 28 detects over-charging and over-discharging, and controls ON/OFF of the protection FET 27. When the charged battery 1 is fully charged, and is brought into the over-charged state, the protection circuit 28 turns the protection FET 27 OFF, and stops the charging operation. Also, when the discharged battery 1 is brought into the over-discharged state, the protection circuit 28 turns the protection FET 27 OFF, and stops the discharging operation of the battery.

The hand warmer shown in the circuit diagram of FIG. 8 is connected to an AC adaptor 29, and the AC adaptor 29 supplies direct current for charging the battery 1. The hand warmer includes a DC jack 30 that is connected to the AC adaptor 29, and the DC jack 30 is connected to the charging circuit 25. Since the hand warmer does not include a circuit that converts commercial power to the charge voltage for the battery 1, the charging circuit 25 can be small. However, the hand warmer may be directly connected to commercial power to charge the battery. In this case, the hand warmer includes an AC plug 31 that can be folded and retracted into the case 2 as shown in FIG. 17. The AC plug 31 is connected to a charging circuit with a circuit that converts commercial power to the charge voltage for the battery 1, and charges the battery 1. In thus-configured hand warmer, the AC plug 31 is connected to an outlet so that the battery 1 that is accommodated in the hand warmer can be charged.

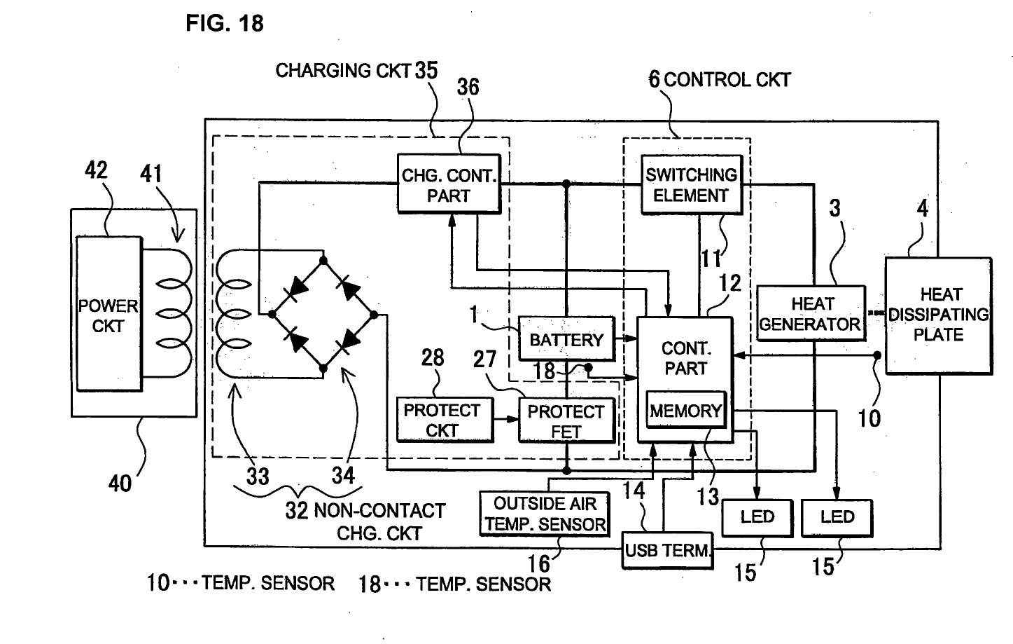

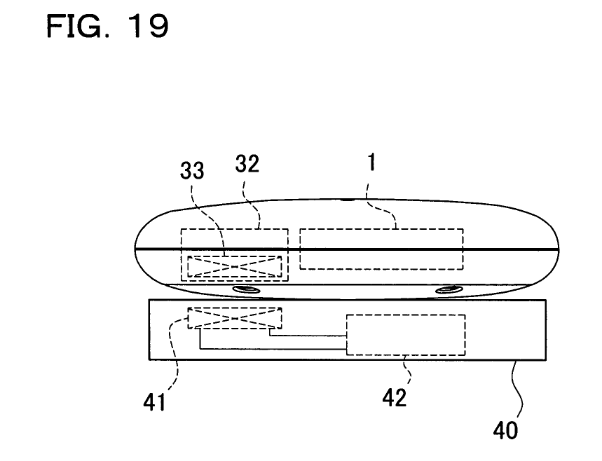

The hand warmer may include a charging circuit 35 that includes a non-contact charging circuit 32 as shown in FIG. 18. The non-contact charging circuit 32 charges the battery 1 that is accommodated in the hand warmer. The charge circuit 35 that includes the non-contact charging circuit 32 includes an induction coil 33, and a rectifying circuit 34 that rectifies alternating current that is induced in the induction coil 33 and converts the alternating current into direct current, as shown in FIG. 18. The output of the rectification circuit 34 is provided to a charge control portion 36, and charges the battery 1. As shown in FIG. 19, the hand warmer that includes the non-contact charging circuit 32 is placed on a charging mount 40 that includes an output coil 41 to charge the battery 1. The charging mount 40 includes the output coil 41 that transfers high frequency electric power to the non-contact charging circuit 32 by using an electromagnetic induction effect, and a power supply circuit 42 that supplies high frequency electric power to the output coil 41. The hand warmer that charges the battery 1 by means of the non-contact charging circuit 32 almost eliminates poor contact of a connector and the like, and can provide convenient charging operation.

In the hand warmer that charges the battery 1 by means of the charging circuit 25 that is supplied with direct current, the charging circuit 25 is connected to the USB connector 14, as shown by a dashed line in FIG. 8. The USB connector 14 is connected to the computer and the like so that the battery 1 is charged.

Although not illustrated, the hand warmer according to this embodiment can additionally have the following features. For example, in the hand warmer, the exterior shape of the case can be formed in the plate shape of a heart. The hand warmer that has the shape in a heart conjunction with warm temperature can provide warm mental feeling to the user. In addition, the heart type hand warmer can have the aforementioned vibration feature, and can be configured to activate the vibrator by button operation when required. The vibration of the thus-configured hand warmer can provide impression, when a person gives the hand warmer as a present to someone, as if the person's heart beats fast to the someone. Also, the case can have an exterior shape, a pattern and the like of a plate-shaped TAIYAKI (fish-shaped pancake). TAIYAKI is a well-known food in Japan, and has an exterior shape, a pattern and the like of a fish symbol. TAIYAKI is made of burned flour mixed with water that contains AN (sweet bean jam). The TAIYAKI type hand warmer can have the aforementioned vibration feature. The thus-configured hand warmer can provide impression as if TAI (a kind of fish) dances, and thus can make the user feel happy. Also, the case can have an exterior shape, a pattern and the like of plate-shaped animals, characters in cartoons, etc., and the like. The thus-configured hand warmer can make the user feel happy. Also, the case can contain an aromatic material, and can have an opening. The thus-configured hand warmer can properly diffuse the aromatic material into air by the temperature of the hand warmer. Also, the hand warmer can additionally have a digital music player feature that uses MP4 and the like.

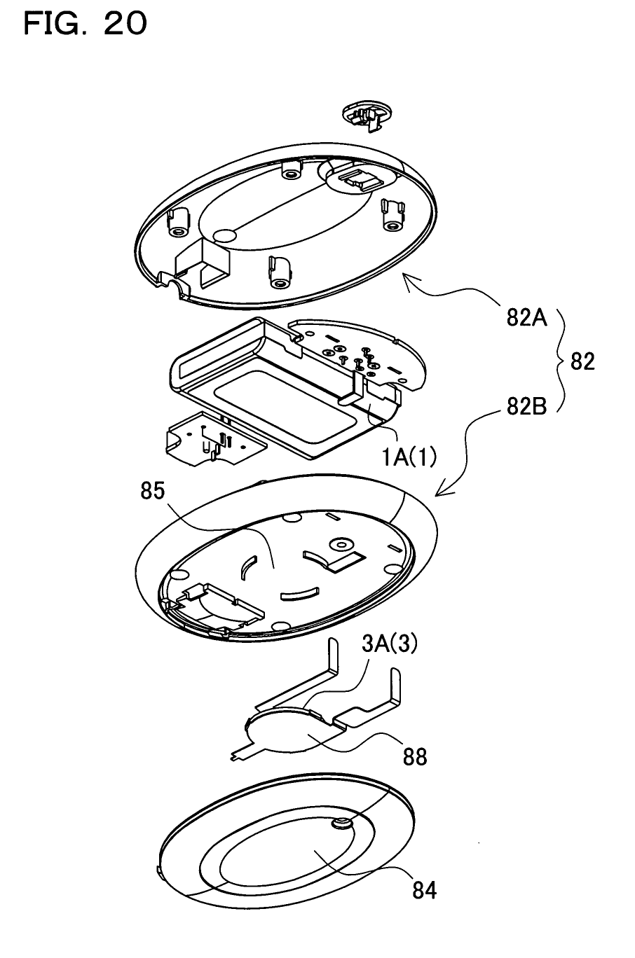

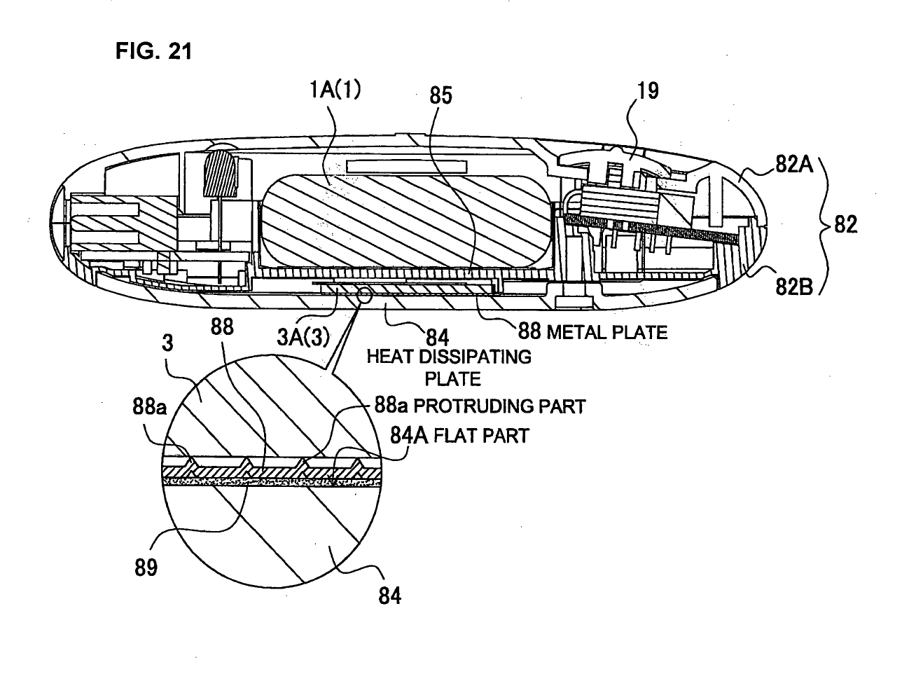

The hand warmer shown in FIGS. 20 and 21 includes one heater 3 in a case 82. The description of the structure and configuration of the hand warmer shown in FIGS. 20, 21 and 22 that are similar to those of the foregoing embodiments is omitted for the sake of brevity. The case 82 is composed of the first and second case members 82A and 82B that are made of plastic and accommodate the box-shaped rechargeable battery 1A. The second case member 82B is formed integrally with a shielding plate 85. A heat dissipating plate 84 is secured under the lower surface of the shielding plate 85. In the state where the heat dissipating plate 84 is secured to the second case member 82B, the heater 3 is arranged between the shielding plate 85 and the heat dissipating plate 84. The heater 3 is arranged in the center part of the heat dissipating plate 84, and uniformly heats the whole surface of the heat dissipating plate 84. The heat dissipating plate 84 has a curved shape that has convexity at the center on the surface side. Paint that emits far-infrared rays is applied on the surface of the heat dissipating plate 84 to be able to efficiently emit far-infrared rays. A flat portion 84A is formed on a part of the interior surface of the heat dissipating plate 84 where the heat dissipating plate 84 is thermally coupled to the heater 3. The heater 3 is arranged inside the flat portion 84A of the heat dissipating plate 84. The heat of the heater 3 is effectively thermally conducted to the heat dissipating plate 84. Thermally coupling paste 89 such as silicon is applied between the heat dissipating plate 84 and the heater 3 to be able to increase the heat conduction efficiency between the heater 3 and the heat dissipating plate 84.

In the illustrated hand warmer, a metal plate 88 that supplies current to the heater 3 is arranged between the heater 3 and the heat dissipating plate 84. This arrangement is suitable for the configuration where the flat-shaped PTC heater 3A is used as the heater 3. The metal plate 88 is in contact with an electrode that is arranged on the surface of the flat-shaped PTC heater 3A, and supplies current to the flat-shaped PTC heater 3A. Protruding portions 88a are arranged and protrude at locations on the metal plate 88 in order to ensure electrical connection between the metal plate 88 and the flat-shaped PTC heater 3A. The protruding portions 88a are in contact with the electrode on the surface of the flat-shaped PTC heater 3A to provide the electrical connection. The metal plate 88 has a flat shape as a whole, and is thermally coupled to the flat portion 84A of the heat dissipating plate 84 in the surface contact state. The thermally coupling paste 89 such as silicon is applied between the flat portion 84A of the heat dissipating plate 84 and the metal plate 88 to increase the heat conduction efficiency between the heat dissipating plate 84 and the metal plate 88.

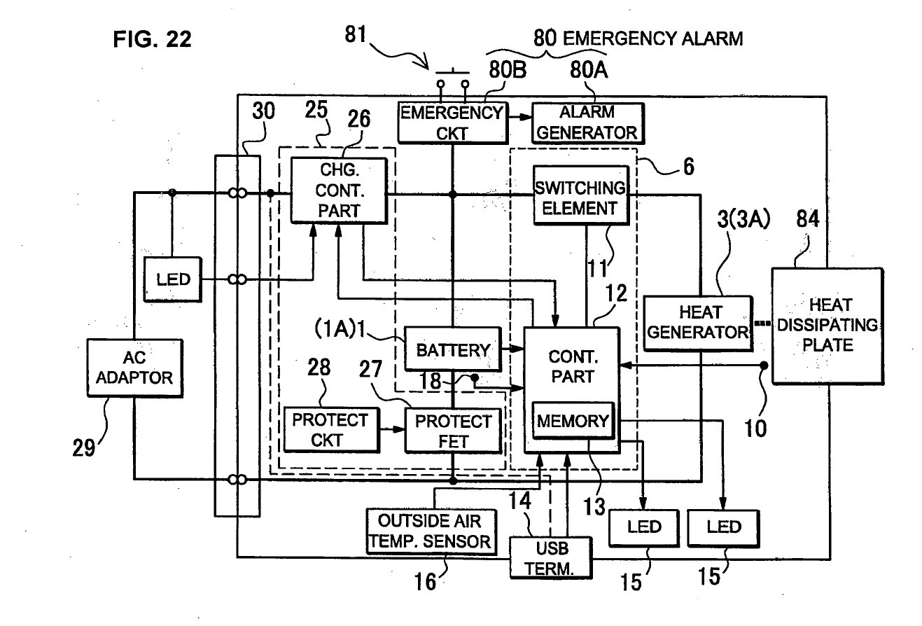

In the thus-configured hand warmer, since the heat of the flat-shaped PTC heater 3A is not directly conducted to the heat dissipating plate 84 but is conducted to the heat dissipating plate 84 via the metal plate 88, it is possible to reduce the temperature variation of the heat dissipating plate 84 with respect to the temperature variation of the flat-shaped PTC heater 3A. The switching element 11 is connected between the battery 1 as a power supply and the flat-shaped PTC heater 3A as shown in FIG. 22, and is controlled to be turned ON/OFF so that the flat-shaped PTC heater 3A is controlled to be brought to the preset temperature value When the switching element 11 is turned ON, the flat-shaped PTC heater 3A is heated. When the switching element 11 is turned OFF, the flat-shaped PTC heater 3A is not heated. Accordingly, the temperature of the flat-shaped PTC heater 3A varies by ON/OFF control of the switching element 11. Such temperature variation can be prevented by the configuration where the heat of the flat-shaped PTC heater 3A is conducted to the heat dissipating plate 84 via the metal plate 88. In the control circuit 6, the control portion 12 conducts the duty cycle control where the switching element 11 is turned ON/OFF, and controls the temperature of the flat-shaped PTC heater 3A. The control circuit 6 detects the temperature of the flat-shaped PTC heater 3A by means of the temperature sensor 10, and conducts the duty cycle control of the switching element 11. In the hand warmer that conducts the duty cycle control of the switching element 11 by means of the temperature sensor 10, time delay of the flat-shaped PTC heater 3A temperature detection may occur and may cause that the temperature of the flat-shaped PTC heater 3A becomes higher or lower than the preset temperature value. Such a defect can be prevented by the configuration where the heat of the flat-shaped PTC heater 3A is conducted to the heat dissipating plate 84 via the metal plate 88.

In the control circuit 6 that conducts the duty cycle control where the switching element 11 is turned ON/OFF to control the temperature of the flat-shaped PTC heater 3A, the control circuit 6 can continuously supply current to the flat-shaped PTC heater 3A to warm the flat-shaped PTC heater 3A to the preset temperature value within a very short time in the early stage after the power switch 19 of the hand warmer is turned ON. When the flat-shaped PTC heater 3A becomes the preset temperature value, the switching element 11 is turned ON/OFF by the duty cycle control to control the temperature of the flat-shaped PTC heater 3A.

A hand warmer shown in FIG. 22 includes an emergency alarm 80. The emergency alarm 80 is supplied with electric power from the battery 1 that supplies current to the heater 3. The emergency alarm 80 that is installed in the hand warmer includes an alarm generator 80A, and an emergency alarm circuit 80B that controls the alarm generation of the alarm generator 80A. The emergency alarm circuit 80B is connected to an alarm switch 81. The alarm switch 81 is a switch that is turned ON when a pin is pulled out of the switch by pulling a cord, or is turned ON/OFF by pulling a cord. This type of switch is used for available emergency alarms. However, the emergency switch may be a switch that is arranged on the exterior side of the case to be turned ON/OFF.

When the alarm switch 81 is turned ON, the emergency alarm circuit 80B supplies current to the alarm generator 80A by using electric power that is supplied from the battery 1 to generate an audible alarm. The emergency alarm circuit 80B is supplied with electric power at a higher priority than the heater 3 of the hand warmer. The control portion 12 detects the remaining capacity or the voltage of the battery 1. When the remaining capacity or the voltage of the battery 1 become smaller than a predetermined value, the switching element 11 is turned OFF to cut off current to the heater 3, and therefore only the emergency alarm 80 is supplied with electric power. In the thus-configured hand warmer, even in the case where the heat dissipating plate 84 cannot be warmed by means of the battery 1, the emergency alarm 80 can be used. Since power consumption of the emergency alarm 80 is small as compared with the power consumption of the heater 3, and, in particular, the power consumption of the emergency alarm 80 is very small in the state where the alarm generator 80A does not generate an audible alarm, the emergency alarm 80 can be used for a considerably long time after current to the heater 3 is cut off.

The hand warmer that includes the emergency alarm 80 has the following advantageous features.

(1) In the emergency, the emergency alarm can be quickly operated.

Most conventional emergency alarms are hung from a school backpack or bag. There is a problem in that it is difficult to pull a cord when turning the alarm switch ON in emergency. In contrast to this, in the hand warmer that includes the emergency alarm according to the present invention, since the user normally uses the hand warmer in the state where the user holds the hand warmer with user's hand, or carries the hand warmer in user's pocket, the user can quickly operate the emergency alarm. In particular, in the state where the user holds the hand warmer with user's hand, or carries the hand warmer in user's pocket, there is a feature in that offenders are not aware that the user has the emergency alarm. For this reason, there is little worry that the user is robbed of the emergency alarm by an offender and cannot use the emergency alarm.

(2) Even when the user walks at cold night, the emergency alarm can be surely operated.

In these days, there has been a growth in the use of emergency alarms by children and students who go to after-hours cram schools. Also, because of a rising number of groping and stalking crimes, there has been a growth in the use of emergency alarms by women who walk at night. The reason is that, when meeting an offender, women cannot shout due to fear. However, when the user walks at cold night, for example, fingers may not move well due to the cold, and therefore they may not operate emergency alarms in emergency. According to the hand warmer including the emergency alarm according to the present invention, since user's fingers can be warmed by the function of the hand warmer, even when the user walks at cold night, it is possible to prevent that the user cannot activate the emergency alarm. Also, warming user's fingers or body can provide an effect that allays fear when the user walks at dark and cold night.

(3) The remaining capacity of the battery can be checked.

The conventional emergency alarms have a disadvantage in that it is difficult to check the remaining capacity of the battery. The reason is that it is necessary to turn the alarm switch ON to generate an audible alarm. If the alarm switch is turned ON, a large amount of audible alarm is generated. Since such a large amount of audible alarm surprises people or attracts attention, it is almost impossible to constantly check the remaining capacity. However, if a battery of an emergency alarm has run down, this causes a serious problem in emergency. In contrast to this, in the hand warmer according to the present invention, since the warmth of the hand warmer can show the user whether the battery has the remaining capacity or not, the user can use the emergency alarm with a feeling of security.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims.

The present application is based on Application No. 2006-220714 filed in Japan on Aug. 11, 2006, No. 2006-292527 filed in Japan on Oct. 27, 2006, and No. 2007-204766 filed in Japan on Aug. 6, 2007, the contents of which are incorporated herein by reference.

What is claimed is:

1. A hand warmer comprising:
a battery;
a case that accommodates the battery;
a heater that is supplied with current to generate heat by the battery that is accommodated in the case; and
a heat dissipating plate that is thermally coupled to the heater, wherein
the battery is a box-shaped rechargeable battery of a box-shaped rechargeable lithium-ion battery or lithium-polymer battery that has flat surfaces opposed to each other, wherein the heater is a heating element that is opposed to the flat surface of the battery, and a shielding plate is arranged between the heating element and the flat surface of the battery, wherein the heat dissipating plate that is formed of a metal plate that is thermally coupled to the heating element to be heated, and is secured to the case on the surface side of the case, wherein the flat surface of the box-shaped rechargeable battery, the shielding plate, the heating element, and the heat dissipating plate are arranged in a stack structure, and the heating element heats the heat dissipating plate as the surface of the case.

2. The hand warmer according to claim 1, wherein the heating element has a flat shape.

3. The hand warmer according to claim 2, wherein the flat-shaped heating element is arranged in parallel to the flat surface of the battery.

4. The hand warmer according to claim 2, wherein the heating element is a flat-shaped PTC heater.

5. The hand warmer according to claim 1, wherein the case includes first and second case members that are made of plastic and accommodate the box-shaped rechargeable battery, wherein the second case member is formed integrally with the shielding plate, and the heat dissipating plate is secured to the second case member on the surface side, wherein the box-shaped rechargeable battery is arranged between the first case member and the shielding plate, and the heating element is arranged between the shielding plate and the heat dissipating plate.

6. The hand warmer according to claim 1, wherein the hand warmer includes a control circuit that controls the electric power that is supplied from the box-shaped rechargeable battery to the heating element, and a temperature sensor that detects the temperature of the heat dissipating plate, wherein the control circuit controls the supplied power to control the temperature of the heat dissipating plate.

7. The hand warmer according to claim 6, wherein the control circuit conducts control so that an early-stage preset temperature value of the heat dissipating plate is higher than a normal preset temperature value of the heat dissipating plate.

8. The hand warmer according to claim 6, wherein the control circuit includes a switching element that is connected between the battery and the heating element, and a control portion that controls the switching element, wherein the control portion conducts the duty cycle control where the switching element is turned ON/OFF at a predetermined cycle period to control the temperature of the heat dissipating plate.

9. The hand warmer according to claim 1, wherein an outside-air-temperature sensor is arranged on the side opposed to the heating element to determine the not-in-use state of the hand warmer based on the detected temperature of the outside-air-temperature sensor so that power supply is turned OFF.

10. The hand warmer according to claim 1, wherein a vibrator that is driven by the battery is accommodated in the case.

11. The hand warmer according to claim 1, wherein the hand warmer include a plurality of the heating elements that have different preset temperature values, wherein the heating elements are selectively turned ON to be supplied with current to control the temperature of the heat dissipating plate.

12. The hand warmer according to claim 1, wherein the heating elements and the heat dissipating plates are arranged on the both sides of the battery so that the shielding plates are interposed between the heating elements and the battery.

13. The hand warmer according to claim 6, wherein the control circuit includes a memory that stores a preset temperature value, wherein the hand warmer includes a USB connector that is connected to the control circuit, wherein the hand warmer is connected to a computer via the USB connector, and the preset temperature value that is stored in the memory is changed.

14. The hand warmer according to claim 6, wherein a plurality of LEDs are disposed in the case, and the control circuit includes a memory that stores the flashing state of the LEDs, wherein the hand warmer includes a USB connector that is connected to the control circuit, wherein the hand warmer is connected to a computer via the USB connector, and the flashing state of the LEDs that is stored in the memory is changed.

15. The hand warmer according to claim 1, wherein the surface of the heat dissipating plate is covered by an elastomer member.

16. The hand warmer according to claim 4, wherein the flat-shaped PTC heater is connected to the battery in series to serve as a protection circuit for the battery.

17. The hand warmer according to claim 6, wherein the control circuit includes a temperature sensor that detects the temperature of the battery, wherein the heating element pre-warms the battery when the battery temperature is lower than a preset temperature value.

18. The hand warmer according to claim 1, wherein the battery is a lithium-polymer battery, and the heat dissipating plate and the case are deformable.

19. The hand warmer according to claim 1, wherein the case accommodates a charging circuit for the battery.

20. The hand warmer according to claim 19, wherein the charge circuit includes a no-contact charging circuit.

21. The hand warmer according to claim 19, wherein the charging circuit is connected to a USB connector, and the battery is charged via the USB connector.

22. The hand warmer according to claim 19, wherein an AC plug is disposed in the case and is connected to the charging circuit, and the AC plug is connected to an outlet to charge the battery.

23. The hand warmer according to claim 1, wherein the heat dissipating plate has a number of recessed and protruding parts on the surface of the heat dissipating plate.

24. The hand warmer according to claim 1, wherein the heat dissipating plate has a flat portion on the interior side of the heat dissipating plate, and the flat portion is thermally coupled to the heater.

25. The hand warmer according to claim 1, wherein a metal plate is arranged between the heat dissipating plate and the heater to supply current to the heater, wherein the metal plate is in surface contact with and is thermally coupled to the heat dissipating plate, and the metal plate is electrically connected to the heater via a protruding portion of the metal plate.

26. The hand warmer according to claim 1, wherein the hand warmer includes an emergency alarm that is supplied with electric power from the battery that supplies current to the heater.

27. The hand warmer according to claim 26, wherein the hand warmer includes a control portion that detects the remaining capacity or voltage of the battery, and cuts off current for the heater and supplies electric power only to the emergency alarm when the remaining capacity or voltage becomes smaller than a predetermined value.

28. A hand warmer comprising:
a battery;
a case that accommodates the battery;
a heater that is supplied with current to generate heat by the battery that is accommodated in the case; and
a heat dissipating plate that is thermally coupled to the heater, wherein
the battery is a box-shaped rechargeable battery of a box-shaped rechargeable lithium-ion battery or lithium-polymer battery that has flat surfaces opposed to each other, wherein the heater is a flat-shaped heating element that is opposed to the flat surface of the battery, wherein the heat dissipating plate that is formed of a metal plate that is thermally coupled to the heating element to be heated, and is secured to the case on the surface side of the case, wherein the heating element heats the heat dissipating plate as the surface of the case.

29. The hand warmer according to claim 28, wherein the hand warmer further includes a control portion that detects the remaining capacity of the battery, a power switch that is disposed in the case and turns power supply ON/OFF, an LED that is disposed in the case and can emit light in previously set different flashing patterns in accordance with the remaining capacity of the battery, wherein when the power switch is turned OFF, the control portion detects the remaining capacity of the battery, and controls so that the LED emits light in different flashing patterns in accordance with the detected remaining capacity of the battery.
